(19) United States
(12) Patent Application Publication
(10) Pub. No.: US 2026/0366308 A1
(43) Pub. Date: Nov. 19, 2026

(54) DECORATIVE SURFACE COVERING COMPRISING PVB

(71) Applicant: TARKETT GDL, Lentzweiler (LU)

(72) Inventor: Guillaume Chatte, Wiltz (LU)

(73) Assignee: TARKETT GDL, Lentzweiler (LU)

(21) Appl. No.: 19/121,022

(22) PCT Filed: Oct. 9, 2023
(86) PCT No.: PCT/EP2023/077886

§ 371 Date: Apr. 14, 2025

(30) Foreign Application Priority Data
Oct. 19, 2022 (LU) 502923

(51) Int. Cl. E04F 15/10; B32B 3/06; B32B 27/20; B32B 27/22; B32B 27/30; C08F 124/00; E04F 13/08; E04F 13/18; E04F 15/02

(52) U.S. Cl. CPC E04F 15/107; B32B 3/06; B32B 27/20; B32B 27/22; B32B 27/306; C08F 124/00; E04F 13/0894; E04F 13/18; E04F 15/02038; B32B 2250/05; B32B 2305/70; B32B 2307/546; B32B 2471/00; E04F 2201/023; E04F 2201/042; E04F 2201/043

(57) ABSTRACT

A preferably PVC-free surface covering comprises a core layer, a décor layer or décor layer assembly, and, optionally, a backing layer. The core layer is a stiff layer possessing a deformation angle of less than 10 degrees, preferably less, as measured for a rectangular sample with dimensions of 160 mm×450 mm, clamped in a horizontal cantilevered position so as to obtain a 160×300 mm projecting portion, the deformation angle being measured 30 seconds after removal of a support that prevents a deformation of the projecting part under the influence of its own weight. The core layer comprises thermoplastic material containing PVB. The thermoplastic material has a plasticizer content of not more than 20 wt. %, preferably less, with respect to the PVB content.

### BACKGROUND OF THE INVENTION

The invention generally relates to decorative surface coverings, such as, e.g., floor coverings (flooring) or wallcoverings including PVB (polyvinyl butyral, poly[(2-propyl-1,3-dioxane-4,6-diyl)methylene), in particular, recycled PVB.

PVB is a polymer resin with interesting properties for various applications. PVB has outstanding optical transparency, the ability to bond to inorganic materials such as metal, glass and ceramics, a high toughness. PVB is widely used in interlayers of safety glass, e.g., for vehicles, buildings, and other applications. Other applications include thermoplastic processing, but, due to its vinyl alcohol units, PVB can also be employed in cross-linking compositions (e.g., in combination with epoxy resin or isocyanate).

EP 0 950 688 A1 discloses a polyvinyl chloride (PVC) floor covering comprising PVB and magnesium hydroxide in addition to conventional additives.

EP 0 853 097 A1 relates to a thermoplastic blend, which can be processed to form resilient flooring, and which comprises polyvinyl butyral and a polymer which contains a polar moiety which is effective to form a hydrogen bond with the polyvinyl butyral. The polymer having the polar moiety may be selected from among polyethylene methacrylic acid, the partial metal salt of polyethylene methacrylic acid, polyethylene acrylic acid, polyethylene vinyl acetate, polyamide, polyamine, a thermoplastic urethane, polyvinyl alcohol, polyethylene carbon monoxide, and mixtures thereof.

EP 1 104 783 A1 relates to a floor or wall covering comprising a mixture of PVB resin and ethylene-vinyl acetate (EVA) copolymer, a glycol benzoate plasticizer, fillers, and additives.

WO 93/02141 A1 discloses a process for recycling PVB, wherein waste PVB is melt-blended with an incompatible polymer having a melt processing temperature less than the PVB decomposition temperature and an effective amount of anhydride-modified polymer that compatibilizes the resultant blend.

EP 0 471 658 A2 discloses floorings and flooring compositions containing recycled plasticized PVB resin. The recycled PVB may contain up to 10% by weight of minute glass particles, due to the sourcing of the PVB from laminated safety glass.

EP 1 599 335 A1 uses post-consumer and/or post-industrial PVB (recovered or recycled PVB or PVB waste) as an ingredient of the backcoating, precoat and main backcoat compositions of floor coverings such as carpeting, pile carpets and carpet tiles. The document more specifically proposes mixtures of recycled PVB, plasticizer and filler; mixtures of recycled PVB, plasticizer, ethylene vinyl acetate (EVA) and filler; mixtures of recycled PVB, tackifier composition(s), EVA, and filler (and, optionally, a plasticizer); mixtures of recycled PVB, plasticizer, anionic surfactant, and filler; as well as extruded recycled PVB alone or in combination with fillers or other additives. The recycled PVB compositions are considered to have excellent chemical and physical properties, long term durability and compatibility with other floorings. The recycled PVB may comprise glass particles and other contaminants. The recycled PVB is processed to separate the PVB from glass and other components through shredding and density differences. As a rule, recycled PVB contains plasticizer (typically between about 30 to about 50 phr). EP 1 599 335 A1 specifies that the recycled PVB can contain plasticizers (and other contaminants) for the purposes disclosed therein.

DE 4 202 948 A1 discloses floor coverings comprising 30-60% recycled PVB, 5-20% polyacrylate (PA) and 20-60% filler. Optional additives include pigments, UV-stabilizers, flame retardants, antistatic agents, or antibacterial agents. The document mentions a plasticizer content of 5-50% for the recycled PVB but it is clear from the document that low plasticizer content is not considered desirable. If the plasticizers introduced into the composition via the recycled PVB are not sufficient, further plasticizer(s), e.g., plasticizers compatible with both PVB and PA, can be added to the composition. The document also discusses the possibility of blending recycled PVB, containing plasticizer, with a sufficient amount of unplasticized virgin PVB and about the same amount of filler, and forming floor coverings with the composition thus obtained. It is mentioned that the floor coverings exhibit shortcomings in terms of residual indentation and stability in the presence of moisture.

### SUMMARY OF THE INVENTION

According to an aspect of the invention, a surface covering, e.g., a floor covering, or a wallcovering is proposed. The surface covering is preferably a PVC-free surface covering, i.e., a surface covering comprising less than 0.5%, preferably less than 0.2%, more preferably less than 0.1%, most preferably less than 0.05%, by weight of PVC (polyvinyl chloride). The surface covering may comprise a core layer, a décor layer or décor layer assembly, and, optionally, a backing layer.

The core layer may be a stiff core layer possessing a deformation angle of less than 10 degrees, preferably of less than 7 degrees, more preferably of less than 5 degrees, most preferably of less than 3 degrees, as measured by the following deformation test (cantilever test) carried out in ambient conditions of temperature and pressure (at 23 °C and at atmospheric pressure, i.e., about 1000 hPa). According to the deformation test, a rectangular sample (in this case of the core layer) with dimensions of 160 mm×450 mm, is clamped in a horizontal cantilevered position so as to obtain a 160×300 mm projecting part of the sample. The projecting portion is initially supported over its entire length and width by a removable horizontal support. The deformation angle is measured 30 seconds after removal of the support that prevents the deformation of the projecting part under the influence of its own weight. The deformation angle corresponds to the angle between the horizontal support plane and the plane extending from the edge of the support from which the projecting portion projects to the lowermost extremity of the projecting portion. The deformation angle is a measure of the flexural strength of the structure being tested. According to one embodiment, the core layer has a flexural modulus of over 500 MPa, preferably over 1000 MPa, more preferably over 1500 MPa, and most preferably over 3000 MPa. According to another embodiment, the core layer has a flexural modulus of less than 20 000 MPa, preferably of less than 12 000 MPa and more preferably of less than 10 000 MPa. Preferably, the core layer has a flexural modulus which is comprised in between 1000 MPa and 10 000 MPa. The flexural modulus is determined from the slope of a stress-strain curve produced by a flexural test (3-point bending test) measured on a 50 mm wide×80 mm long sample (the length extension corresponding to the machine direction).

The core layer may comprise a thermoplastic material containing PVB. The thermoplastic material preferably has a plasticizer content (overall plasticizer content) of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, preferably of not more than 5 wt. %, more preferably of not more than 3 wt. %, yet more preferably of not more than 2 wt. % and still more preferably of not more than 1%, with respect to the PVB content. According to a specific embodiment, the core layer may have a plasticizer content which is comprised from 5 wt. % to 18 wt. % with respect to the PVB content and more preferably from 8 to 14 wt. % with respect to the PVB content. When reference is made herein to the PVB content, this means the amount of PVB polymer (resin), not including any plasticizer, additive or contaminant.

It may be noted that the core layer may comprise a unique layer or plural layers (core layer assembly). The term “core layer” may designate those layers of the surface covering on the back of the décor layer or décor layer assembly that form the structural support of the décor layer or décor layer assembly. The optional backing layer, which may comprise one or more resilient foam layers and/or one or more textile layers, is normally not considered to be part of the core layer. The core layer may comprise one or more reinforcement layers, such as, e.g., glass or fibre veils, glass or fibre grids, textile layers, etc., the one or more reinforcement layers being embedded in or adjacent to the thermoplastic material. The core layer may comprise two or more thermoplastic materials, e.g., arranged in different layers.

A particularly preferred core layer assembly may comprise three or more layers, including two outer layers sandwiching one or more inner layers. In this case, the outer layers may preferably comprise a first thermoplastic material, while the one or more inner layers comprise at least a second thermoplastic material different from the first one. Preferably, the outer layers are of (essentially) the same chemical constitution. The outer layer may have the same thickness or be of different thicknesses. The first thermoplastic material of the outer layers is preferably the thermoplastic material containing PVB having the low plasticizer content. The thermoplastic material of the inner layer(s) could be a different thermoplastic material containing PVB having a low plasticizer content. It should, however, be noted that the inner layer(s) could, alternatively, comprise a thermoplastic PVB material having a higher plasticizer content.

According to preferred embodiments of the invention, the thermoplastic material may include deplasticized recycled PVB (recycled PVB from which plasticizer has been removed). The presence of deplasticized recycled PVB within the thermoplastic material may be detected due to the presence of residual contaminants, in particular, glass particles or plasticizers, which have not been removed during the recycling process. Recycled PVB is typically sourced from laminated glass by mechanical peeling or mechanical cracking followed by chemical separation in aqueous alkali solution. Although separation may be efficient, a residual content of glass particles may characterize the recycled PVB. Deplasticized recycled PVB may contain residual amounts of plasticizers, preferably less than 20 wt. %, more preferably less than 10 wt. %, more preferably less than 8 wt. %, still more preferably less than 5 wt. %, yet more preferably less than 3 wt. %, yet still more preferably less than 2 wt. %, and yet still more preferably less than 1 wt. %, with respect to the PVB content. It was found that for the present invention, the lower the plasticizer content of the PVB, the better are normally the properties of the surface covering. Nevertheless, experimental product tests showed that satisfactory results can already be reached if the plasticizer content of the thermoplastic material does not exceed 20 wt. % with respect to the PVB content. Better results may be achieved when the plasticizer content of the thermoplastic material does not exceed 15 wt. %, more preferably 12.5 wt. %, with respect to the PVB content. An interesting advantage of using recycled PVB resides in reduced carbon footprint.

The surface covering may take the form of a surface covering tile comprising a first locking profile along a first edge, a second locking profile along a second edge, the first and second locking profiles being complementary so that the surface covering tile can be interlocked with another surface covering tile by engaging the first or the second locking profile of the surface covering tile with the second or first locking profile of the other surface covering tile. The expression “surface covering tile” designates a piece of surface covering, such as, e.g., a tile, a plank, a panel, or the like, which can be assembled with other pieces of flooring so as to serve as a finish on a surface, e.g., an underfloor. Preferred examples of surface covering tiles include flooring tiles, in particular, rigid flooring tiles.

The plasticizer content of the thermoplastic material may include a content of plasticizers being aliphatic diesters of tri- or tetraethylene glycols from 0.1 wt. % to 20 wt. %, preferably from 0.1 wt. % to 15 wt. %, preferably from 0.1 wt. % to 10 wt. %, preferably from 0.1 wt. % to 5 wt. %, more preferably from 0.1 wt. % to 2 wt. %, still more preferably from 0.1 wt. % to 1 wt. %, and most preferably from 0.1 wt. % to 0.5 wt. % with respect to the PVB content. Preferably, the plasticizer content includes a content of triethylene glycol bis(2-ethylhexanoate) from 0.1 wt. % to 19.5 wt. %, preferably from 0.1 wt. % to 15 wt. %, preferably from 0.1 wt. % to 10 wt. %, preferably from 0.1 wt. % to 5 wt. %, more preferably from 0.1 wt. % to 2 wt. %, still more preferably from 0.1 wt. % to 1 wt. %, and most preferably from 0.1 wt. % to 0.5 wt. % with respect to the PVB content. Apart from the above, the thermoplastic material may include plasticisers suitable for plasticizing PVB; in particular, the esters of multivalent acids, polyhydric alcohols or oligoether glycols, such as e.g. adipic acid esters, sebacic acid esters, ricinoleic acid esters, citric acid esters or phthalic acid esters, in particular di-n-hexyl adipate, dibutyl sebacate, dibutyl maleate, dioctyl phthalate, esters of ethylene glycol, diglycol, triglycol or tetraglycol with linear or branched aliphatic carboxylic acids and mixtures of these esters may be suitable. Esters of aliphatic diols with long chain aliphatic carboxylic acids, in particular esters of triethylene glycol with aliphatic carboxylic acids containing 6 to 10 C atoms, such as 2-ethyl butyric acid or n-heptanoic acid may be present. One or several plasticisers selected among di-n-hexyl adipate, dibutyl sebacate, dioctyl phthalate, esters of diglycol, triglycol or tetraglycol with linear or branched aliphatic carboxylic acids, in particular triethylene glycol-bis-2-ethyl butyrate, triethylene glycol-bis-n-heptanoate, tetraethylene glycol-bis-n-heptanoate may be present in the thermoplastic material. Ethers of ethylene glycol may also be considered as plasticizers. It shall be understood, however, that, preferably, each of the above-recited plasticizers is present, at most, to an amount less than 15 wt. %, preferably less than 10 wt. %, more preferably less than 5 wt. %, with respect to the PVB content, under the general proviso that the overall content in plasticizer(s) of the thermoplastic material amounts to not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, yet more preferably of not more than 3 wt. %, still more preferably of not more than 2 wt. %, and yet still more preferably of not more than 1 wt. % with respect to the PVB content.

PVB is a random terpolymer comprised of vinyl butyral, vinyl alcohol (VA) and vinyl acetate (VAc) monomer moieties. Virgin PVB is obtained by the condensation reaction of polyvinyl alcohol, itself typically obtained through hydrolysis of polyvinyl acetate (resulting in the presence of a few residual VAc), and butyraldehyde. Recycled PVB is available in different grades and is significantly cheaper than virgin PVB. The PVB may advantageously comprise from 17 wt. % to 23 wt. %, preferably from 18 wt. % to 21 wt. %, still more preferably from 19 wt. % to 21 wt. %, vinyl alcohol (VA). Preferably, the PVB comprises at most 3 wt. % VAc, preferably at most 2.5 wt. % VAc, more preferably at most 2 wt. % VAc, still more preferably at most 1.5 wt. % VAc and most preferably at most 1 wt. % VAc.

The thermoplastic material may contain filler dispersed in the thermoplastic polymer matrix, but need not contain such filler in certain embodiments. Filler contents from 10 to 500 wt. % with respect to the PVB content (10 to 500 phr) may be chosen. Advantageously, a filler content from 50 to 400 wt. %, preferably from 80 to 300 wt. %, more preferably from 100 to 250 wt. % with respect to the PVB content, may be chosen. The filler may comprise organic filler material such as, e.g., ground cork, wood flour, cellulose fibers, bleached chemical wood pulp, etc., and/or mineral filler material such as, e.g., ground limestone, chalk, magnesium carbonate, dolomite, clay, silica, aluminium trihydroxide, magnesium dihydroxide, precipitated calcium carbonate, glass fibers and/or glass particles, etc. Lamellar or fibrous fillers may be used to advantageously modify the mechanical properties of the thermoplastic material, e.g., the thermal expansion coefficient. Fibrous fillers usable in the context of embodiments of the invention may include glass fibers, or biomass fibers, like bamboo fibers, hemp fibers, flax fibers, wood fibers, etc., preferably delignified cellulosic fibers. Particularly preferred fillers may include inorganic lamellar fillers, such as, e.g., sheet silicate (in particular, talc or mica), clay, montmorillonite, glass flake, and lamellar double hydroxide. The term “sheet silicate” refers to minerals from the group of silicates wherein the silicate anions are usually arranged in layers, e.g., phyllosilicates. By way of example, phyllosilicates may include minerals from the mica group, the chlorite group, the kaolinite group, and the serpentine group. The filler or part of the filler may be or include biochar, i.e., solid material, rich in carbon, obtained by thermochemical conversion of biomass in an oxygen-poor environment (reducing atmosphere) or by thermo-catalytic depolymerization of biomass. The thermoplastic material may have a biochar content from 50 to 400 wt. %, preferably from 80 to 300 wt. %, more preferably from 80 to 250 wt. %, and still more preferably from 80 to 100 wt. %, with respect to the PVB content.

The thermoplastic material may further comprise one or more additives, such as, e.g., lubricant(s), stabilizer(s), filler compatibilizer(s). The additives content of the thermoplastic material may be limited to 10 wt. % or less, e.g., to 8 wt. % or less or 7 wt. % or less, with respect to the PVB content.

The PVB of the thermoplastic material may comprise at least 50 wt. %, preferably at least 60 wt. %, more preferably at least 70 wt. %, still more preferably at least 80 wt. %, yet more preferably at least 90 wt. %, and most preferably 100 wt. %, of deplasticized recycled PVB.

Optionally, the thermoplastic material comprises at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

The surface covering may comprise a décor layer assembly, the décor layer assembly comprising a decorative print and a transparent or translucent wear layer, the wear layer optionally comprising or consisting of a crosslinked topcoat (e.g., comprising epoxy, polyurethane, polyurethane acrylate, polyester polyurethane acrylate, polyurethane methacrylate and/or polyester polyurethane methacrylate), the décor layer assembly optionally comprising an embossed pattern in register with the decorative print. The wear layer and the topcoat could each comprise or be built from one or plural layers. These could be distinguishable from each other in the final product or not. The decorative print may comprise a digital print or a print generated by analogous printing technique such as, e.g., rotogravure, photogravure, offset printing, or the like.

According to embodiments, the surface covering may take the form of a rigid surface covering tile, e.g., a flooring tile. Such surface covering tile is preferably rigid in the sense that it exhibits a deformation angle of less than 3 degrees, preferably of less than 2 degrees, preferably of less than 1 degree, as measured for a rectangular sample tile with dimensions of 160 mm×450 mm, clamped in a horizontal cantilevered position so as to obtain a 160×300 mm projecting part of the sample, the deformation angle being measured 30 seconds after removing a support that prevents a deformation of the projecting portion under the influence of its own weight.

The thermoplastic material of the core layer may have the form of at least one foam layer. Additionally, or alternatively, the surface covering may comprise a backing layer, the backing layer preferably comprising a foam backing. The core layer may be fabricated by direct extrusion through a flat die. In case of a core layer assembly, co-extrusion may be used. As an alternative, the core layer (assembly) may be obtained by compaction (under heat and pressure) of precompounded granules of thermoplastic material.

According to a preferred embodiment, a PVC-free surface covering in the form of a surface covering tile (preferably a flooring tile) comprises a core layer, a décor layer or décor layer assembly, and, optionally, a backing layer. The core layer is a stiff core layer possessing a deformation angle of less than 10 degrees, preferably of less than 7 degrees, more preferably of less than 5 degrees, most preferably of less than 3 degrees, as measured by the deformation test described above. The core layer comprises a thermoplastic material containing PVB, wherein the thermoplastic material has an (overall) plasticizer content of not more than 2 wt. % and more preferably of not more than 1 wt. %, with respect to the PVB content. The PVB of the thermoplastic material preferably consists of deplasticized recycled PVB containing from 17 wt. % to 23 wt. %, preferably from 18 wt. % to 21 wt. %, vinyl alcohol. The plasticizer content may include a content of plasticizers being aliphatic diesters of tri- or tetraethylene glycols, in particular triethylene glycol bis(2-ethylhexanoate), from 0.1 wt. % to 2 wt. % with respect to the PVB content. The thermoplastic material further preferably comprises at most 10 wt. %, with respect to the PVB content, of synthetic polymers other than PVB. The thermoplastic material preferably has a filler content from 50 to 400 wt. %, more preferably from 80 to 300 wt. %, still more preferably from 100 to 250 wt. % with respect to the PVB content. The thermoplastic material preferably comprises one or more additives, such as, e.g., a lubricant, a stabilizer, a filler compatibilizer, the additives content of the thermoplastic material amounting to less than 10 wt. % with respect to the PVB content. The surface covering tile preferably comprises a first locking profile along a first edge, a second locking profile along a second edge, the first and second locking profiles being configured mutually complementarily so that the surface covering tile can be interlocked with another surface covering tile by engaging the first or the second locking profile of the surface covering tile with the second or first locking profile of the other surface covering tile.

According to another embodiment, a PVC-free surface covering in the form of a surface covering tile (preferably a flooring tile) comprises a core layer, a décor layer or décor layer assembly, and, optionally, a backing layer. The core layer is a stiff core layer possessing a deformation angle of less than 10 degrees, preferably of less than 7 degrees, more preferably of less than 5 degrees, most preferably of less than 3 degrees, as measured by the deformation test described above. The core layer comprises a thermoplastic material containing PVB, wherein the thermoplastic material has an (overall) plasticizer content of from 5 wt. % to 18 wt. % and more preferably from 8 to 14 wt. % with respect to the PVB content. The PVB of the thermoplastic material preferably consists of deplasticized recycled PVB containing from 17 wt. % to 23 wt. %, preferably from 18 wt. % to 21 wt. %, vinyl alcohol. The plasticizer content may include a content of plasticizers being aliphatic diesters of tri- or tetraethylene glycols, in particular triethylene glycol bis(2-ethylhexanoate), from 5 wt. % to 18 wt. % and more preferably from 8 wt. % to 14 wt. % with respect to the PVB content with respect to the PVB content. The thermoplastic material further preferably comprises at most 10 wt. %, with respect to the PVB content, of synthetic polymers other than PVB. The thermoplastic material preferably has a filler content from 50 to 400 wt. %, more preferably from 80 to 300 wt. %, still more preferably from 100 to 250 wt. % with respect to the PVB content. The thermoplastic material preferably comprises one or more additives, such as, e.g., a lubricant, a stabilizer, a filler compatibilizer, the additives content of the thermoplastic material amounting to less than 10 wt. % with respect to the PVB content. The surface covering tile preferably comprises a first locking profile along a first edge, a second locking profile along a second edge, the first and second locking profiles being configured mutually complementarily so that the surface covering tile can be interlocked with another surface covering tile by engaging the first or the second locking profile of the surface covering tile with the second or first locking profile of the other surface covering tile. The PVC-free surface covering may also comprise at least one reinforcing fiber layer, preferably at least two reinforcing fiber layers such as: veils, grids or textiles made from reinforcing fibers, e.g., glass fibers, aramid fibers, ultra-high-molecular-weight polyethylene (UHMWPE) fibers, or the like. The addition of one or more reinforcing fiber layer(s) in the PVC-free surface covering may allow controlling the thermal expansion of the core layer which might occur due to the plasticizer content of from 5 wt. % to 18 wt. % and more preferably from 8 to 14 wt. % with respect to the PVB content.

According to still more preferred variants of the above preferred embodiment, the surface covering tile comprises a décor layer assembly, the décor layer assembly comprising a decorative print and a transparent or translucent wear layer, the wear layer optionally comprising or consisting of a crosslinked topcoat, the décor layer assembly optionally comprising an embossed pattern in register with the decorative print. The surface covering tile preferably possesses a deformation angle of less than 3 degrees, more preferably of less than 2 degrees, and still more preferably of less than 1 degree, as measured by the above-described deformation test. The thermoplastic material of the core layer may take the form of one or more foam layers. The surface covering tile may further comprise a backing layer, the backing layer preferably comprising a foam backing.

Terms such as “up”, down”, “lower”, “upper”, “horizontal”, “vertical”, “above”, “below”, “top” and “bottom” as well as derivatives thereof (e.g., “horizontally”, “upwards”, etc.) refer to the orientation of a surface covering tile laid with its decorative face oriented upwards. For a flooring tile or flooring, this orientation corresponds to the position of the flooring tile or flooring when in use, i.e., laid on the floor. The terms referring to orientation of the surface covering are employed herein for convenience of description and as a naming convention. They shall be construed to refer to the relative orientation of the different parts but are not meant to imply a particular absolute orientation of the tile or flooring component in space. E.g., arranging a tile with its decorative face upside down shall not prevent the decorative face from being considered the top surface.

The qualifier “decorative”, as used herein, is intended to imply that the item thereby qualified, such as the surface covering, remains visible in normal use (as an item of finishing work). The use of the term, should not, however, be taken to imply any particular aesthetic appearance or any particular aesthetic design. The expression “décor layer” designates a layer with a decorative motif. Examples of décor layers include print layers, in particular, rotogravure-printed layers and digitally printed layers.

The expression “surface normal” refers to the direction perpendicular to the surface of the decorative side (the top side) of the surface covering.

As used herein, the expression “thermoplastic material” encompasses plastic polymer material blends that become pliable or moldable at a certain elevated temperature and solidify upon cooling, the solidification being reversible by heating the material again to the elevated temperature. Thermoplastic (polymer) material may comprise thermoplastic polymers and, optionally, one or more plasticizers, (mineral or organic) fillers, and further additives (e.g., impact modifiers, compatibilizers, processing aids). Thermoplastic polymers include, for example: polyacrylic acid, polyacrylate, polyamide, polyester, polylactic acid (PLA), polycarbonate, polyether sulfone (PES), polyether ether ketone (PEEK), polyetherimide (PEI), polyethylene, polypropylene (PP), polystyrene, polyvinyl chloride (PVC), polyvinylidene fluoride (PVDF), acrylonitrile butadiene styrene (ABS), etc. In the present context, the thermoplastic material comprises PVB. Other thermoplastic polymers may be present in the thermoplastic material but according to preferred embodiments, the thermoplastic material comprises significantly less other synthetic polymers (in particular thermoplastic polymers) than PVB. In the context of the present document, two or more initially separate thermoplastic materials that have been intimately blended together have to be considered, in their blended state, as one thermoplastic material. Accordingly, when reference is made herein to a surface covering or any component thereof comprising two or more thermoplastic materials, it is understood that these two or more thermoplastic materials are present in physically separate volumes, e.g., in different layers, in different distinguishable granules, or the like.

In contrast to “thermoplastic”, the expression “crosslinked” qualifies polymer material (such as, e.g., a topcoat) that has been irreversibly hardened through crosslinking between polymer chains so as to generate an infusible and insoluble network of polymer. Crosslinked (polymer) material may include, e.g., one or more thermoset or radiation-cured polymers. Radiation-cured polymers include, in particular, UV-cured and/or electron-beam-cured polymers. Crosslinked (polymer) material may comprise thermoset and/or radiation-cured polymers (e.g., polyurethane, polyimide, epoxy, etc.) and, optionally, one or more plasticizers, (mineral or organic) fillers, and further additives (e.g., impact modifiers, photoinitiators, antioxidants, etc.) or processing aids.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance, hierarchy, or limitation in number is intended to be implied by the use of these expressions. Furthermore, when plural instances of an object are referred to by ordinal numbers, this does not necessarily mean that no other instances of that object are present (unless this follows clearly from context). When this description refers to “an embodiment”, “one embodiment”, “embodiments”, etc., this means that the features of those embodiments can be used in the combination explicitly presented but also that the features can be combined across embodiments without departing from the invention, unless it follows from context that features cannot be combined.

(Residual) plasticizer content may be measured using different methods. For instance, nuclear magnetic resonance (NMR) could be used, e.g., a MQC23+ Benchtop NMR Analyzer (Oxford Instruments) could be employed. Alternative methods for measuring the plasticizer content include dissolving the plasticizer in organic solvent and determining the plasticizer content by gravimetric analysis following distillation, gas chromatography and/or infrared spectroscopy. The preferred method uses DMA (dynamic mechanical analysis) to determine the glass transition temperature Tg of a sample in accordance with ISO 6721-11:2019 (determination of the temperature of the peak in the curve of loss factor (tan(delta)) vs. temperature). Procedure B of ISO 6721-11:2019 is preferably used (temperature rate of 2.5 K/min frequency of 1 Hz). If the sample is of known composition (except for the plasticizer content), the plasticizer content is derived from a calibration curve or calibration table (lookup table) linking the Tg to the plasticizer content for the given composition. If the composition of the sample is not initially known, the different components (resin, filler, plasticizer species, etc.) thereof are determined in a first step. Different comparative samples are then prepared with different precisely metered contents of plasticizer and the calibration curve or calibration table (lookup table) linking the Tg to the plasticizer content for the given composition is determined by measuring the Tg of the comparative samples in accordance with ISO 6721-11:2019 using the tan(delta) method. The plasticizer content of the sample under examination may then be determined using the calibration curve or calibration table. Indications of plasticizer content in this document refer to the preferred method based on the determination of the glass temperature and reference values (calibration curve(s) or table(s)).

### BRIEF DESCRIPTION OF THE DRAWINGS

By way of example, preferred, non-limiting embodiments of the invention will now be described in detail with reference to the accompanying drawings, in which:

FIG. 1: is a cross-sectional schematic view of a surface covering tile according to an embodiment of the invention;

FIG. 2: is an illustration of the deformation test, showing the cantilevered sample in the initial supported position; and

FIG. 3: is an illustration of the deformation test, showing the cantilevered sample after removal of the support of the projecting portion.

### DETAILED DESCRIPTION OF PREFERRED EMBODIMENTS

LVT flooring assembled by click is one of the fastest-growing flooring categories due to the numerous advantages (easy installation, suitable for renovation including uneven subfloors, watertightness . . . ) The core layer of those products is quite thick (e.g., 3-6 mm) and often semi-rigid or rigid (stiffness ranging from 0.5-2 GPa and from 2 GPa-10 GPa (or higher) respectively). Generally, filled PVC is used as matrix polymer but there is a growing demand for alternatives to PVC (compliance with some local regulations, concerns with PVC in some regions . . . ) suitable for LVT floorings. According to an aspect of the present invention PVB-based LVT flooring is proposed. According to a particularly preferred aspect, such PVB-based flooring tiles are substantially or completely PVC-free.

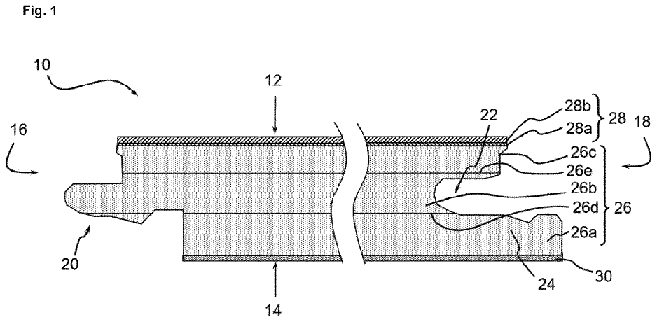

FIG. 1 shows a “vinyl”-type flooring panel 10 according to an embodiment of the invention. The flooring panel 10 may be a rigid luxury vinyl tile (LVT). The flooring panel 10 has a having a top surface 12, a bottom surface 14 and at least four side edges. FIG. 1 shows a first edge 16 and a complementarily shaped second edge 18 in more detail. The first edge 16 may comprise a first locking profile featuring a tongue 20 and the second edge 18 may comprise a second locking profile featuring a groove 22. The first and second locking profiles may be configured mutually complementarily for mechanically engaging and interlocking with a second and a first connection profile, respectively, of another flooring panel of the same type. Specifically, the tongue 20 and the groove 22 may be complementarily shaped, so as to enable a tongue-and-groove connection between neighboring panels. The groove 22 may be delimited at its bottom by a base 24.

The flooring panel 10 may be of a layered structure and include a core layer 26 and a décor layer assembly 28 arranged on the core layer 26. The core layer 26 may be rigid. The décor layer assembly 28 may comprise a print layer 28a (e.g., a printing substrate carrying one or more digital printed ink layers) and a transparent or translucent wear layer 28b. The print layer 28a could also be printed directly on the core layer 26. As a further possibility, the print layer 28a could be printed on the backside of the wear layer 28b before the wear layer 28b and the core layer are laminated so as to sandwich the print layer 28a. A backing layer 30, e.g., a resilient foam layer, a felt layer or a fleece layer, may be arranged on the bottom side 14 of the flooring panel 10.

The core layer 26 may comprise plural sublayers, e.g., one or more PVB-based thermoplastic layers 26a, 26b, 26c and one or more reinforcing fiber layers 26d, 26e. Fiber layers 26d, 26e may comprise veils, grids or textiles made from reinforcing fibers, e.g., glass fibers, aramid fibers, ultra-high-molecular-weight polyethylene (UHMWPE) fibers, or the like. The one or more fiber layers 26d, 26e may be embedded in or adjacent to the one or more PVB-based thermoplastic layers 26a, 26b, 26c. If the core layer 26 comprises plural PVB-based thermoplastic sublayers 26a, 26b, 26c, these may be made from thermoplastic materials of the same or two or more different compositions. It may be worthwhile noting, however, that the core layer 26 could, alternatively, comprise the same PVB material throughout its height.

The flooring panel 10 may have an overall height in the range from 2 to 10 mm, preferably in the range from 2.5 mm to 9 mm, and most preferably in the range from 2.5 mm to 8.5 mm.

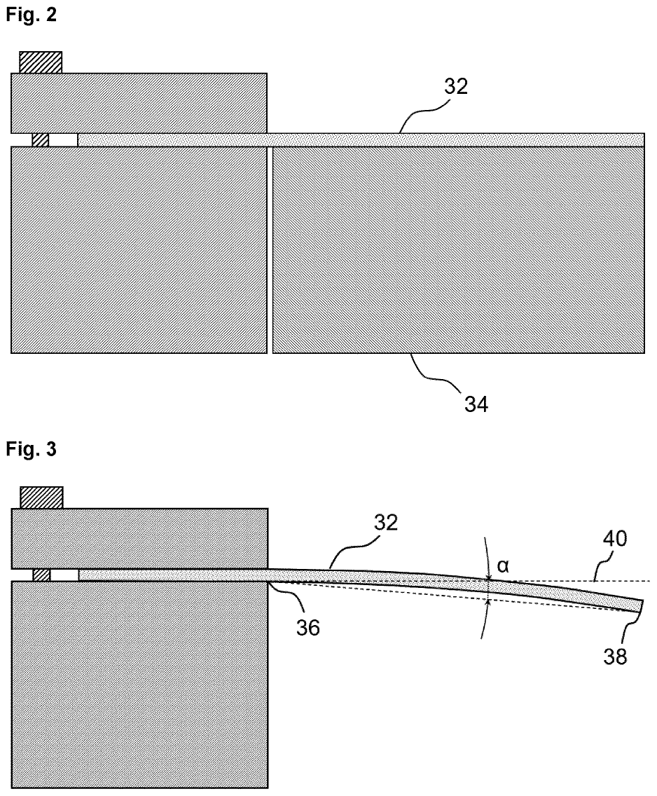

The core layer 26 may possess a deformation angle (α) of less than 10 degrees, preferably of less than 7 degrees, more preferably of less than 5 degrees, most preferably of less than 3 degrees, as measured by the deformation test. To carry out the deformation test, illustrated in FIGS. 2 and 3, a 160 mm×450 mm rectangular sample 32 of the core layer 26 (including sublayers 26a, 26b, 26c, 26d, 26e in the illustrated embodiment) or other layer (assembly) is prepared. The sample 32 is than is clamped in a horizontal cantilevered position so as to obtain a 160×300 mm rectangular projecting part of the sample. The projecting part is initially supported over its entire length and width by a removable horizontal support. This support is then removed so that the projecting part bends under its own weight. The deformation angle α is measured 30 seconds after removal of the support 34 that prevents the deformation of the projecting part under the influence of its own weight. The deformation angle α corresponds to the angle between the horizontal support plane 40 and the plane extending from the edge 36 of the support from which the projecting portion projects to the lowermost extremity 38 of the projecting portion. The core layer 26 may also show a flexural modulus of over 500 MPa, preferably over 1000 MPa, more preferably over 1500 MPa, and most preferably over 3000 MPa. The flexural modulus is determined from the slope of a stress-strain curve produced by a flexural test (3-point bending test) measured on a 50 mm wide×80 mm long sample (the length extension corresponding to the machine direction).

The PVB-based thermoplastic material(s) of the core layer 26 may have a plasticizer content (overall plasticizer content) of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, more preferably of not more than 3 wt. %, yet more preferably of not more than 2 wt. %, and still yet more preferably of not more than 1 wt. % with respect to the PVB content. More specifically, the PVB-based thermoplastic material(s) include a content of plasticizers being aliphatic diesters of tri- or tetraethylene glycols (such as, e.g., triethylene glycol bis(2-ethylhexanoate)) from 0.1 wt. % to 19.5 wt. %, preferably from 0.1 wt. % to 15 wt. %, preferably from 0.1 wt. % to 10 wt. %, preferably from 0.1 wt. % to 5 wt. %, more preferably from 0.1 wt. % to 2 wt. %, still more preferably from 0.1 wt. % to 1 wt. %, and most preferably from 0.1 wt. % to 0.5 wt. % with respect to the PVB content.

The PVB-based thermoplastic material(s) preferably include deplasticized recycled PVB. The PVB-based thermoplastic material(s) may include virgin PVB but according to preferred embodiments, the totality of the PVB is deplasticized recycled PVB. The PVB may comprise from 17 wt. % to 23 wt. %, preferably from 18 wt. % to 21 wt. %, still more preferably from 19 wt. % to 21 wt. %, vinyl alcohol (VA). Preferably, the PVB comprises at most 3 wt. % VAc, preferably at most 2.5 wt. % VAc, more preferably at most 2 wt. % VAc, still more preferably at most 1.5 wt. % VAc and most preferably at most 1 wt. % VAc. The PVB-based thermoplastic material(s) preferably comprises at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

The PVB-based thermoplastic material(s) may contain filler or may be devoid of filler. Filler contents from 10 to 500 wt. % with respect to the PVB content may be chosen. Advantageously, a filler content from 50 to 400 wt. %, preferably from 80 to 300 wt. %, more preferably from 100 to 250 wt. % with respect to the PVB content, may be chosen. Fillers may comprise organic filler material such as, e.g., biochar, ground cork, wood flour, cellulose fibers, bleached chemical wood pulp, etc., and/or mineral filler material such as, e.g., ground limestone, talc, chalk, magnesium carbonate, dolomite, clay, silica, aluminium trihydroxide, pigment(s), etc

The PVB-based thermoplastic material(s) may further comprise one or more additives, such as, e.g., lubricant(s), stabilizer(s), filler compatibilizer(s). The additives content of the thermoplastic material may be limited to 10 wt. % or less, e.g., to 8 wt. % or less or 7 wt. % or less, with respect to the PVB content.

Examples of PVB-based thermoplastic compositions for flooring panels in accordance with preferred embodiments of the invention are indicated in Table 1 below. The quantities of the ingredients or components are indicated in parts per weight.

TABLE 1
PVB-Based thermoplastic compositions

| | Example | | | | | | | | | | |
|---|---|---|---|---|---|---|---|---|---|---|---|
| Ingredient | E1 | E2 | E3 | E4 | E5 | E6 | E7 | E8 | E9 | E10 | E11 |
| Medium molecular | 100 | | | | | | | | | | |
| weight virgin PVB | | | | | | | | | | | |
| High molecular weight | | 100 | 100 | | | | | | | | |
| virgin PVB | | | | | | | | | | | |
| Deplasticized recycled | | | | 100 | 100 | 100 | 100 | 100 | 100 | 100 | 100 |
| PVB | | | | | | | | | | | |
| CaCO₃ (filler) | 250 | 200 | | 200 | | | 200 | 100 | 80 | 160 | |
| Talc (filler) | | | 160 | | 160 | | | | | | 160 |
| Biochar (filler) | | | | | | 100 | | 50 | | | |
| ATH (Filler) | | | | | | | | | 80 | | |
| Lubricant package | 2 | 2 | 4 | 2 | 4 | 3 | 3 | 3 | 2.8 | 2.8 | 2.8 |
| Stabilizer package | 0.4 | 0.4 | 0.4 | 0.4 | 0.4 | 0.4 | 0.4 | 0.4 | 0.4 | 0.4 | 0.4 |

In examples E1-E11, medium molecular weight virgin PVB was Mowital B 60 T from Kuraray, high molecular weight virgin PVB was Mowital B 75 H from Kuraray. Deplasticized recycled PVB was obtained by plasticizer extraction from recycled PVB flakes purchased as from Shark Solutions. Calcium carbonate was Omyacarb 15-VA from Omya, talc was Luzenac ST30 from Imerys, Biochar was dust waste from pyrolysis process of Carbonex. Different lubricant packages were adapted according to the examples and included oxidized PE wax (for example Wiraten XW-12 from Wiwax), stearin (Radiacid 0444 from Oleon) and/or zinc stearate (for example Ligastar Zn 101/6 from Peter Greven) as main components. The stabilizer package includes blends of Irganox (Trademark) 1010 from BASF and Irgafos (Trademark) 168 from BASF. ATH filler was Alfrimal (Trademark) 447S from Alpha Calcit. Samples of examples E1-E11 were extruded with a twin screw extruder equipped with a flat die. The melt temperature was close to 180 °C (e.g., comprised between 180 and 210 °C).

The (residual) plasticizer content of the compositions according to the examples was 0 in E1, E2 and E3, 5.2 wt. % w.r.t. to PVB content in E4, 7.8 wt. % w.r.t. to PVB content in E5, 2 wt. % w.r.t. to PVB content in E6, inferior to 1 wt. % w.r.t. to PVB content in E1, 1.2 wt % w.r.t. to PVB content in E8, 13.9 wt. % w.r.t. to PVB content in E9 and E10, and 19.6 w.r.t to PVB content in E11.

Table 2 summarizes a few properties of PVB-based thermoplastic materials according to examples E1-E11.

TABLE 2
PVB-Based thermoplastic compositions

| | E1 | E2 | E3 | E4 | E5 | E6 | E7 | E8 | E9 | E10 | E11 |
|---|---|---|---|---|---|---|---|---|---|---|---|
| Residual plasticizer content | 0 | 0 | 0 | 5.2 | 7.8 | 2 | <1 | 1.2 | 13.9 | 13.9 | 19.6 |
| (wt. % w.r.t. to PVB content) | | | | | | | | | | | |
| Coefficient of Linear Thermal | 5.5 | 4.6 | 3.1 | 9 | 4.5 | 9.5 | 6.4 | 5.8 | 14.4 | 16.0 | 7.3 |
| Expansion (10⁻⁵/°C) | | | | | | | | | | | |
| Stress at break (MPa) | 36 | 41 | 89 | 42 | 75 | 49 | 41 | 54 | 33 | 33 | 32 |
| Flexural modulus (GPa) | 7.6 | 6.9 | 9.2 | 6.2 | 8.7 | 3.6 | 5.5 | 4.2 | 3.5 | 3.3 | 2.5 |
| Glass transition temperature | 80 | 77 | 77 | 68 | 61 | 74 | 78.5 | 75.6 | 54 | 55 | 48 |
| (°C) | | | | | | | | | | | |

The Coefficient of Linear Thermal Expansion (10⁻⁵/°C) has been measured at a temperature within the range of 35 °C and 65 °C. The flexural modulus was determined each time from the slope of a stress-strain curve produced by a flexural test (3-point bending test) measured on a 50 mm wide×80 mm long sample (the length extension corresponding to the machine direction). A span of 64 mm was used for the 3-point bending setup. A preload was applied at a speed of 5 mm/min (until a force 5N was reached) before the test starts. The load was then displaced at a rate of 4%/min until break. The flexural modulus was determined as the initial slope of the stress-strain curve. The flexural modulus has been measured on a sample equilibrated at 23 °C. The stress at break indicated in Table 2 corresponds to the respective maximum recorded stress.

As indicated in Table 2, it was found that stiff PVB exhibits good thermomechanical properties (stress at break, low thermal dilatation, good planar stability . . . ) and are thus suitable for use in core layers of rigid LVTs with locking connectors. It may be worthwhile noting that surface coverings according to the invention may have a stiffness that is unachievable with conventional plasticized PVB.

Table 3 summarizes a few properties of core layers (CL) made of PVB-based thermoplastic materials according to examples E7, E8, E9, E10 and E11.

TABLE 3
Core layers

| | CL1 | CL2 | CL3 | CL4 | CL5 | CL6 | CL7 |
|---|---|---|---|---|---|---|---|
| Reinforcement | / | 2 glass | 2 glass | / | 2 glass | / | / |
| layers | | veils | veils | | veils | | |
| | | (embedded) | (adjacent) | | (embedded) | | |
| Types of | E10 | E10 | E9 | E11 | E11 | E7 | E8 |
| thermoplastic | | | (upper)/ | | | | |
| material | | | E10 | | | | |
| | | | (lower) | | | | |
| Thickness | 3.9 | 4.6 | 5.3 | 5 | 5 | 5.2 | 4.8 |
| (mm) | | | | | | | |
| Coefficient of | 16.0 | 2.1 | 3.3 | 7.3 | 2.1 | 6.4 | 5.8 |
| Linear Thermal | | | | | | | |
| Expansion | | | | | | | |
| (10⁻⁵/°C) | | | | | | | |
| Stress at break | 33 | 34 | 41 | 31 | 27 | 41 | 54 |
| (MPa) | | | | | | | |
| Flexural | 3.3 | 3.4 | 2.5 | 2.5 | 1.9 | 5.5 | 4.2 |
| modulus (GPa) | | | | | | | |

Glass veils used in these examples were Adfors (Trademark) U35 from Adfors. Core layers CL1, CL4, CL6 and CL7 were extruded with a twin screw extruder equipped with a flat die. Core layers CL2, CL3 and CL5 were obtained by compaction (under heat and pressure) of precompounded granules of thermoplastic material.

As indicated in table 3, all the core layers according to the invention exhibit good thermomechanical properties (stress at break, low thermal dilatation, good planar stability . . . ) and are thus suitable for use in rigid LVTs with locking connectors. It has to be noted that the coefficient of linear thermal expansion may be significantly reduced by adding at least one reinforcement layer in the core layer.

Flooring assembled from flooring tiles according to the invention including the PVB-based compositions according to examples E1-E11 were subjected to the Castor chair test as specified in standard ISO 4918:2016. The flooring tiles comprised locking connectors along their edges. After 25000 cycles, no damage was noted on the flooring surface and the locking connectors.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

Particularly preferred embodiments of the invention are defined in the following numbered clauses (NCs).

NC 1: A surface covering, preferably a PVC-free surface covering, comprising a core layer, a décor layer or décor layer assembly, and, optionally, a backing layer, wherein: the core layer is a stiff core layer possessing a deformation angle of less than 5 degrees, most preferably of less than 3 degrees, as measured at 23 °C for a rectangular core layer sample with dimensions of 160 mm×450 mm, clamped in a horizontal cantilevered position so as to obtain a 160×300 mm projecting part of the sample, the deformation angle being measured 30 seconds after removal of a support that prevents a deformation of the projecting part under the influence of its own weight, the core layer comprising a thermoplastic material containing PVB, wherein the thermoplastic material has a plasticizer content of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, more preferably of not more than 3 wt. %, yet more preferably of not more than 2 wt. %, and still more preferably of not more than 1 wt. % with respect to the PVB content.

NC 2: The surface covering as recited in NC 1, wherein the thermoplastic material includes deplasticized recycled PVB.

NC 3: The surface covering as recited in NC 1 or 2, in the form of a surface covering tile comprising a first locking profile along a first edge, a second locking profile along a second edge, the first and second locking profiles being complementary so that the surface covering tile can be interlocked with another surface covering tile by engaging the first or the second locking profile of the surface covering tile with the second or first locking profile of the other surface covering tile.

NC 4: The surface covering as recited in any one of NCs 1 to 3, wherein the plasticizer content includes a content of plasticizers being aliphatic diesters of tri- or tetraethylene glycols not exceeding 20 wt. %, preferably not exceeding 15 wt. %, preferably not exceeding 10 wt. %, with respect to the PVB content.

NC 5: The surface covering as recited in NC 4, wherein the plasticizer content includes a triethylene glycol bis(2-ethylhexanoate) content not exceeding 19.5 wt. %, preferably not exceeding 15 wt. %, preferably not exceeding 10 wt. %,with respect to the PVB content.

NC 6: The surface covering as recited in any one of NCs 1 to 5, wherein the PVB comprises from 17 wt. % to 23 wt. %, preferably from 18 wt. % to 21 wt. %, vinyl alcohol.

NC 7: The surface covering as recited in any one of NCs 1 to 6, wherein the thermoplastic material has a filler content from 50 to 400 wt. %, preferably from 80 to 300 wt. %, more preferably from 100 to 250 wt. % with respect to the PVB content.

NC 8: The surface covering as recited in any one of NCs 1 to 7, wherein the thermoplastic material comprises one or more additives, such as, e.g., a lubricant, a stabilizer, a filler compatibilizer, the additives content of the material being less than 10 wt. % with respect to the PVB content.

NC 9: The surface covering as recited in any one of NCs 1 to 8, wherein the PVB of the thermoplastic material comprises at least 50 wt. %, preferably at least 60 wt. %, more preferably at least 70 wt. %, still more preferably at least 80 wt. %, yet more preferably at least 90 wt. %, and most preferably 100 wt. %, of deplasticized recycled PVB.

NC 10: The surface covering as recited in any one of NCs 1 to 9, wherein the thermoplastic material comprises at most 20 wt. %, preferably at most 15 wt. %, more preferably at most 10 wt. %, more preferably at most 8 wt. %, still more preferably at most 5 wt. %, yet preferably at most 2 wt. % and most preferably at most 1 wt %, with respect to the PVB content, of synthetic polymers other than PVB.

NC 11: The surface covering as recited in any one of NCs 1 to 10, wherein the surface covering comprises a décor layer assembly, the décor layer assembly comprising a decorative print and a transparent or translucent wear layer, the wear layer optionally comprising or consisting of a crosslinked topcoat, the décor layer assembly optionally comprising an embossed pattern in register with the decorative print.

NC 12: The surface covering as recited in any one of NCs 1 to 11, in the form of a rigid flooring tile, exhibiting a deformation angle of less than 3 degrees, preferably of less than 2 degrees, preferably of less than 1 degree, as measured at 23 °C for a rectangular sample tile with dimensions of 160 mm×450 mm, clamped in a horizontal cantilevered position so as to obtain a 160×300 mm projecting portion of the sample, the deformation angle being measured 30 seconds after removing a support that prevents a deformation of the projecting portion under the influence of its own weight.

NC 13: The surface covering as recited in any one of NCs 1 to 13, wherein the thermoplastic material of the core layer has the form of at least one foam layer and/or wherein the surface covering comprises a backing layer, the backing layer preferably comprising a foam backing.

NC 14: The surface covering in accordance with NCs 1 to 10 taken in combination, wherein the thermoplastic material has a plasticizer content of not more than 2 wt. % with respect to the PVB content, wherein the PVB of the thermoplastic material consists of deplasticized recycled PVB, and wherein the thermoplastic material comprises at most 10 wt. %, with respect to the PVB content, of synthetic polymers other than PVB.

NC 15: The surface covering in accordance with NCs 11 to 14 taken in combination.

NC 16: A surface covering, preferably a PVC-free surface covering, comprising a core layer, a décor layer or décor layer assembly, and, optionally, a backing layer, wherein: the core layer is a stiff core layer possessing a deformation angle of less than 5 degrees, most preferably of less than 3 degrees, as measured at 23 °C for a rectangular core layer sample with dimensions of 160 mm×450 mm, clamped in a horizontal cantilevered position so as to obtain a 160×300 mm projecting part of the sample, the deformation angle being measured 30 seconds after removal of a support that prevents a deformation of the projecting part under the influence of its own weight, the core layer comprising a thermoplastic material containing PVB, wherein the thermoplastic material has a plasticizer content of not more than 12.5 wt. %, preferably of not more than 10 wt. %, preferably of not more than 8 wt. %, more preferably of not more than 5 wt. %, more preferably of not more than 3 wt. %, yet more preferably of not more than 2 wt. %, and still more preferably of not more than 1 wt. % with respect to the PVB content.

NC 17: The surface covering as recited in NC 16, wherein the thermoplastic material includes deplasticized recycled PVB.

NC 18: The surface covering as recited in NC 16 or 17, in the form of a surface covering tile comprising a first locking profile along a first edge, a second locking profile along a second edge, the first and second locking profiles being complementary so that the surface covering tile can be interlocked with another surface covering tile by engaging the first or the second locking profile of the surface covering tile with the second or first locking profile of the other surface covering tile.

NC 19: The surface covering as recited in any one of NCs 16 to 18, wherein the plasticizer content includes a content of plasticizers being aliphatic diesters of tri- or tetraethylene glycols from 0.1 wt. % to 20 wt. %, preferably from 0.1 wt. % to 15 wt. %, preferably from 0.1 wt. % to 10 wt. %, with respect to the PVB content.

NC 20: The surface covering as recited in NC 19, wherein the plasticizer content includes a triethylene glycol bis(2-ethylhexanoate) content lower than 12 wt. %, with respect to the PVB content.

NC 21: The surface covering as recited in any one of NCs 16 to 20, wherein the PVB comprises from 18 wt. % to 21 wt. %, vinyl alcohol.

NC 22: The surface covering as recited in any one of NCs 16 to 21, wherein the thermoplastic material comprises one or more fillers, and wherein the thermoplastic material has a filler content from 50 to 400 wt. %, preferably from 80 to 300 wt. %, more preferably from 100 to 250 wt. % with respect to the PVB content.

NC 23: The surface covering as recited in any one of NCs 16 to 22, wherein the thermoplastic material comprises one or more additives, such as, e.g., a lubricant, a stabilizer, a filler compatibilizer, the additives content of the material being less than 10 wt. % with respect to the PVB content.

NC 24: The surface covering as recited in any one of NCs 16 to 23, wherein the PVB of the thermoplastic material comprises at least 50 wt. %, preferably at least 60 wt. %, more preferably at least 70 wt. %, still more preferably at least 80 wt. %, yet more preferably at least 90 wt. %, and most preferably 100 wt. %, of deplasticized recycled PVB.

NC 25: The surface covering as recited in any one of NCs 16 to 24, wherein the thermoplastic material comprises at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

NC 26: The surface covering as recited in any one of NCs 16 to 25, wherein the surface covering comprises a décor layer assembly, the décor layer assembly comprising a decorative print and a transparent or translucent wear layer, the wear layer optionally comprising or consisting of a crosslinked topcoat, the décor layer assembly optionally comprising an embossed pattern in register with the decorative print.

NC 27: The surface covering as recited in any one of NCs 16 to 26, in the form of a rigid flooring tile, exhibiting a deformation angle of less than 3 degrees, preferably of less than 2 degrees, preferably of less than 1 degree, as measured at 23 °C for a rectangular sample tile with dimensions of 160 mm×450 mm, clamped in a horizontal cantilevered position so as to obtain a 160×300 mm projecting portion of the sample, the deformation angle being measured 30 seconds after removing a support that prevents a deformation of the projecting portion under the influence of its own weight.

NC 28: The surface covering as recited in any one of NCs 16 to 27, wherein the thermoplastic material of the core layer has the form of at least one foam layer and/or wherein the surface covering comprises a backing layer, the backing layer preferably comprising a foam backing.

NC 29: The surface covering in accordance with NCs 16 to 25 taken in combination, wherein the thermoplastic material has a plasticizer content of not more than 2 wt. % with respect to the PVB content, wherein the PVB of the thermoplastic material consists of deplasticized recycled PVB, and wherein the thermoplastic material comprises at most 10 wt. %, with respect to the PVB content, of synthetic polymers other than PVB.

NC 30: The surface covering in accordance with NCs 26 to 29 taken in combination.

The NC 31: The surface covering as recited in any one of NCs 1 to 30, wherein the thermoplastic material comprises one or more lamellar fillers.

NC 32: The surface covering as recited in NC 31, wherein the one or more lamellar fillers include phyllosilicate.

NC 33: The surface covering as recited in NC 31, wherein the one or more lamellar fillers include talc.

NC 34: surface covering as recited in NC 31, wherein the one or more lamellar fillers include talc.

NC 35: surface covering as recited in NC 31, wherein the one or more lamellar fillers include clay.

NC 35: The surface covering as recited in NC 31, wherein the thermoplastic material has a lamellar filler content from 50 to 400 wt. %.

NC 36: The surface covering as recited in NC 31, wherein the thermoplastic material has a lamellar filler content from 100 to 300 wt. %.

1. A surface covering, preferably a PVC-free surface covering, comprising a core layer, a decor layer or decor layer assembly, and, optionally, a backing layer, wherein: the core layer is a stiff core layer possessing a deformation angle of less than 10 degrees, preferably of less than 7 degrees, more preferably of less than 5 degrees, most preferably of less than 3 degrees, as measured at 23 °C for a rectangular core layer sample with dimensions of 160 mm×450 mm, clamped in a horizontal cantilevered position so as to obtain a 160×300 mm projecting part of the sample, the deformation angle being measured 30 seconds after removal of a support that prevents a deformation of the projecting part under the influence of its own weight, the core layer comprising a thermoplastic material containing PVB, wherein the thermoplastic material has a plasticizer content of not more than 20 wt. %, preferably of not more than 18 wt. %, preferably of not more than 16 wt. %, preferably of not more than 15 wt. %, preferably of not more than 12.5 wt. %, preferably of not more than 10 wt. %, preferably of not more than 8 wt. %, more preferably of not more than 5 wt. %, more preferably of not more than 3 wt. %, yet more preferably of not more than 2 wt. % and still more preferably of not more than 1 wt %, with respect to the PVB content.

2. The surface covering as claimed in claim 1, wherein the thermoplastic material includes deplasticized recycled PVB.

3. The surface covering as claimed in claim 1, wherein the core layer has a flexural modulus of over 500 MPa, preferably over 1000 MPa, more preferably over 1500 MPa, and most preferably over 3000 MPa.

4. The surface covering as claimed in claim 1, in the form of a surface covering tile comprising a first locking profile along a first edge, a second locking profile along a second edge, the first and second locking profiles being complementary so that the surface covering tile can be interlocked with another surface covering tile by engaging the first or the second locking profile of the surface covering tile with the second or first locking profile of the other surface covering tile.

5. The surface covering as claimed in claim 1, wherein the plasticizer content includes a content of plasticizers being aliphatic diesters of tri or tetraethylene glycols from 0.1 wt. % to 20 wt. %, preferably from 0.1 wt. % to 15 wt. %, preferably from 0.1 wt. % to 10 wt. %, with respect to the PVB content.

6. The surface covering as claimed in claim 5, wherein the plasticizer content includes a content of triethylene glycol bis(2-ethylhexanoate) from 0.1 wt. % to 19.5 wt. %, preferably from 0.1 wt. % to 15 wt. %, preferably from 0.1 wt. % to 10 wt. %, with respect to the PVB content.

7. The surface covering as claimed in claim 1, wherein the PVB comprises from 17 wt. % to 23 wt. %, preferably from 18 wt. % to 21 wt. %, vinyl alcohol.

8. The surface covering as claimed in claim 1, wherein the thermoplastic material has a filler content from 50 to 400 wt. %, preferably from 80 to 300 wt. %, more preferably from 100 to 250 wt. % with respect to the PVB content.

9. The surface covering as claimed in claim 1, wherein the thermoplastic material comprises one or more additives, such as, e.g., a lubricant, a stabilizer, a filler compatibilizer, the additives content of the material being less than 10 wt. % with respect to the PVB content.

10. The surface covering as claimed in claim 1, wherein the PVB of the thermoplastic material comprises at least 50 wt. %, preferably at least 60 wt. %, more preferably at least 70 wt. %, still more preferably at least 80 wt. %, yet more preferably at least 90 wt. %, and most preferably 100 wt. %, of deplasticized recycled PVB.

11. The surface covering as claimed in claim 1, wherein the thermoplastic material comprises at most 20 wt. %, preferably at most 15 wt. %, more preferably at most 10 wt. %, still more preferably at most 8 wt. %, yet more preferably at most 5 wt. %, and most preferably at most 2 wt. %, with respect to the PVB content, of synthetic polymers other than PVB.

12. The surface covering as claimed in claim 1, wherein the surface covering comprises a decor layer assembly, the decor layer assembly comprising a decorative print and a transparent or translucent wear layer, the wear layer optionally comprising or consisting of a crosslinked topcoat, the decor layer assembly optionally comprising an embossed pattern in register with the decorative print.

13. The surface covering as claimed in claim 1, in the form of a rigid flooring tile, exhibiting a deformation angle of less than 3 degrees, preferably of less than 2 degrees, preferably of less than 1 degree, as measured at 23 °C for a rectangular sample tile with dimensions of 160 mm×450 mm, clamped in a horizontal cantilevered position so as to obtain a 160×300 mm projecting portion of the sample, the deformation angle being measured 30 seconds after removing a support that prevents a deformation of the projecting portion under the influence of its own weight.

14. The surface covering as claimed in claim 1, wherein the thermoplastic material of the core layer has the form of at least one foam layer and/or wherein the surface covering comprises a backing layer, the backing layer preferably comprising a foam backing.

15. The surface covering in accordance with claim 1 taken in combination, wherein the thermoplastic material has a plasticizer content of not more than 2 wt. % and preferably of not more than 1 wt. % with respect to the PVB content, wherein the PVB of the thermoplastic material consists of deplasticized recycled PVB, and wherein the thermoplastic material comprises at most 10 wt. %, with respect to the PVB content, of synthetic polymers other than PVB.

16. The surface covering in accordance with claim 1 taken in combination, wherein the thermoplastic material has a plasticizer content which is comprised from 5 wt. % to 18 wt. % and more preferably from 8 to 14 wt. % with respect to the PVB content.

17. The surface covering in accordance with claim 11 taken in combination.
